(19) United States
(12) Patent Application Publication
(10) Pub. No.: US 2025/0267600 A1
(43) Pub. Date: Aug. 21, 2025

(54) SATELLITE SWITCH WITH RESYNCHRONIZATION

(71) Applicant: Nokia Technologies Oy, Espoo (FI)

(72) Inventors: Enric JUAN, Aalborg (DK); Jeroen WIGARD, Aalborg (DK); Ping YUAN, Beijing (CN)

(21) Appl. No.: 18/901,830

(22) Filed: Sep. 30, 2024

(30) Foreign Application Priority Data
Feb. 15, 2024 (WO) PCT/CN2024/077250

(51) Int. Cl. H04W 56/00; H04W 72/1268; H04W 88/06

(52) U.S. Cl. CPC H04W 56/0015; H04W 72/1268; H04W 88/06

(57) ABSTRACT

Embodiments of the present disclosure relate to satellite switch with resynchronization. In an aspect, a terminal device receives, from a network device, an indication for determining time for at least one operation associated with switching from a first satellite to a second satellite. The at least one operation comprises at least one of (i) initiating a resynchronization procedure to the network device via the second satellite or (ii) performing an uplink transmission via the second satellite. The terminal device performs the at least one operation based on the received indication. The embodiments of the present disclosure can avoid scheduling request (SR) bursts at the t-Service and NW overloading due to scheduling a large number of PUSCH transmissions. Therefore, UEs may suffer less risk of long interruptions, and the NW may schedule first UL transmissions of UEs through the target satellite in a distributed manner.

### FIELD

Various example embodiments relate to the field of communications and in particular, to devices, methods, apparatuses and a computer readable storage medium for satellite switch with resynchronization.

### BACKGROUND

In the communications area, there is a constant evolution ongoing in order to provide efficient and reliable solutions for utilizing wireless communication networks. Each new generation has its own technical challenges for handling the different situations and processes that are needed to connect and serve devices connected to the wireless network. To meet the demand for wireless data traffic having increased since deployment of 4th generation (4G) communication systems, efforts have been made to develop an improved 5th generation (5G), pre-5G communication system, 6th generation (6G) communication systems or beyond. The new communication systems can support various types of service applications for terminal devices.

In some wireless communication systems, satellite communication is involved. In such systems, artificial satellites are used to provide communication links between various points on Earth. Due to the low altitude, the satellites move with a speed about 7.5 km/s relative to Earth. In 3rd Generation Partnership Project (3GPP), Earth-fixed cells (EFC) and Earth-moving cells (EMC) are considered. The former entails the satellite continuously adjusts the satellite beam pointing direction to fix a new radio (NR) cell and a NR beam to a specific point on Earth, while the latter option entails the satellite beam pointing direction is fixed and thus the beam footprint (i.e. NR cell) is moving on Earth. In EMC-based Non Terrestrial Network (NTN) the mobility is mainly due to satellite movement as they move much faster than User Equipments (UEs) on the ground.

### SUMMARY

In general, example embodiments of the present disclosure provide a solution for satellite switch with resynchronization.

In a first aspect, there is provided a terminal device. The terminal device comprises at least one processor and at least one memory including computer program codes. The at least one memory and the computer program codes are configured to, with the at least one processor, cause the terminal device to receive, from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and perform the at least one operation based on the received indication.

In a second aspect, there is provided a network device. The network device comprises at least one processor and at least one memory including computer program codes. The at least one memory and the computer program codes are configured to, with the at least one processor, cause the network device to transmit, to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and receive, from the terminal device, the uplink transmission via the second satellite.

In a third aspect, there is provided a method. The method comprises: receiving, at a terminal device and from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and performing the at least one operation based on the received indication.

In a fourth aspect, there is provided a method. The method comprises: transmitting, at a network device and to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and receiving, from the terminal device, the uplink transmission via the second satellite.

In a fifth aspect, there is provided an apparatus comprising means for receiving, at a terminal device and from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and means for performing the at least one operation based on the received indication.

In a sixth aspect, there is provided an apparatus comprising means for transmitting, at a network device and to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and means for receiving, from the terminal device, the uplink transmission via the second satellite.

In a seventh aspect, there is provided a non-transitory computer readable medium comprising program instructions for causing an apparatus to perform at least the method according to any one of the above third to fourth aspect.

In an eighth aspect, there is provided a computer program comprising instructions, which, when executed by an apparatus, cause the apparatus at least to: receive, from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and perform the at least one operation based on the received indication.

In a ninth aspect, there is provided a computer program comprising instructions, which, when executed by an apparatus, cause the apparatus at least to: transmit, to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and receive, from the terminal device, the uplink transmission via the second satellite.

In a tenth aspect, there is provided a terminal device. The terminal device comprises receiving circuitry configured to receive, from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and performing circuitry configured to perform the at least one operation based on the received indication.

In an eleventh aspect, there is provided a network device. The network device comprises transmitting circuitry configured to transmit, to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and receiving circuitry configured to receive, from the terminal device, the uplink transmission via the second satellite.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example communication network in which embodiments of the present disclosure may be implemented;

FIG. 1B illustrates an example architecture of a non-terrestrial network;

FIG. 2 illustrates a flowchart illustrating a process for satellite switch with resynchronization according to some embodiments of the present disclosure;

FIG. 3 illustrates an example process for satellite switch with resynchronization according to some embodiments of the present disclosure;

FIG. 4 illustrates another example process for satellite switch with resynchronization according to some embodiments of the present disclosure;

FIG. 5 illustrates a flowchart of a method implemented at a terminal device according to some embodiments of the present disclosure;

FIG. 6 illustrates a flowchart of a method implemented at a network device according to some embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as 5G New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB, a base station of a 5G system), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Using 5G NR standards to support non-terrestrial networks has been studied during 3GPP releases 15 and 16. In an approved work item for Non Terrestrial Network (NTN) in release 17, the UEs supporting NTN are assumed to have Global Navigation Satellite System (GNSS) capability. In an NTN system, 5G base stations (gNB) or gNB functionality are deployed on board satellites or relayed by gNBs in a transparent way to provide communication coverage over a very large area that may be otherwise unreachable by cellular networks. Such functionality can be used to connect IoT devices globally as well as provide personal communication in remote areas and in disaster relief. There are different types of satellite orbits that have been studied for New Radio (NR) access including Low Earth Orbit (LEO) satellites which orbit at approximately 600 km above the earth. During the Rel-16 study item the typical beam footprint size for a LEO satellite was assumed to be between 100-1000 km radiuses. So, one LEO satellite can cover a very large area on the Earth which may include multiple countries.

In Rel-18, the topic of unchanged physical cell identification (PCI) is addressed, with the goal of reducing the signaling overhead and simplifying RRC procedures for the UE. The working principle is that after a satellite switching, the serving gNB and the cell (on ground) does not change and, therefore, the (majority of the) cell configuration can be kept without changing the PCI, frequency, and other cell configuration parameters (e.g., servingCellconfigCommon). Then, the satellite switching is almost transparent for the UE, that is, it is not required to perform L3 mobility (i.e., handover procedure), thus it can avoid flushing buffers, and it does not need to update the security key.

The conditions for the mechanism to work are: (i) NTN cells must be deployed as quasi-Earth fixed cells (EFC) since the cell coverage's area should not change; (ii) the network (NW) should indicate the UE how/when to re-synchronize after satellite switching; (iii) target satellite information should be provided before satellite switching and via broadcast signalling (no RRC dedicated signalling shall be used to reduce the Uu interface overhead). In Rel-18 the focus is on transparent architecture and the most obvious case is when the cells are provided by the same gNB, i.e. the same cell with the fixed PCI is provided by the same gNB, so only the satellite node is changed. However, theoretically, this could also work with different gNB and potentially even for the regenerative case.

In some solutions, UE actions upon satellite switch are contained. For example, according to Clauses 5.2.2.4.21 and 5.7.19 of TS 38.331, upon receiving System Information Block 19 (SIB19) in an NTN cell, the UE in RRC_CONNECTED shall: start or restart T430 for serving cell with the timer value set to ntn-UlSyncValidityDuration for the serving cell from the subframe indicated by epochTime for the serving cell; if SatSwitchWithReSync and t-Service are included, and the UE supports hard satellite switch with resynchronization. If t-ServiceStart is included and the UE supports soft satellite switch with resynchronization: perform the satellite switch with resynchronization as specified in 5.7.19 between the time indicated by t-ServiceStart and the time indicated by t-Service for the serving cell; else: perform the satellite switch with resynchronization as specified in 5.7.19 at the time indicated by t-Service for the serving cell.

It should be noted that UE should attempt to re-acquire SIB19 before the end of the duration indicated by ntn-UlSyncValidityDuration and epochTime by UE implementation. For satellite switch with re-synchronization in RRC_CONNECTED UE, the UE shall stop timer T430 if running; inform lower layers that uplink (UL) synchronisation is lost due to satellite switch with re-synchronization; start re-synchronizing to the downlink (DL) of the SpCell served by the satellite indicated by ntn-Config in SatSwitchWithReSync; start timer T430 with the timer value set to ntn-UlSyncValidityDuration from the subframe indicated by epochTime in ntn-Config in SatSwitchWithReSync; inform lower layers when UL synchronisation is obtained.

A definition of SIB19 above is contained in Clause 6.3 (RRC information elements) in TS38.331. Specifically, the SIB19 is a NTN-specific SIB used to signal satellite assistance information (including target satellite information for the satellite switch). In SIB 19, optionally, some fields, such as ntn-Config, satSwitchWithReSync, t-Service, ssb-Time Offset and t-ServiceStart are contained. The ntn-Config provides parameters needed for the UE to access NR via NTN access such as Ephemeris data, common Timing Advance (TA) parameters, k_offset, validity duration for UL sync information and epoch. In a Terrestrial Network (TN) cell, this field is only present in ntn-NeighCellConfigList and ntn-NeighCellConfigListExt. The satSwitchWithReSync provides parameters for the target satellite required to perform satellite switch with re-synchronization.

This field is present in an NTN cell and its presence indicates that satellite switch without Physical Cell Identification (PCI) change is supported in the cell. The t-Service indicates the time information on when a cell provided via NTN system is going to stop serving the area it is currently covering. This field applies for both service link switches in NTN quasi-Earth fixed system and feeder link switches for both NTN quasi-Earth fixed and Earth moving system. The field indicates a time in multiples of 10 ms after 00:00:00 on Gregorian calendar date 1 Jan. 1900 (midnight between Sunday, Dec. 31, 1899 and Monday, Jan. 1, 1900). The exact stop time is between the time indicated by the value of this field minus 1 and the time indicated by the value of this field.

The reference point for t-Service is the uplink time synchronization reference point of the cell. This field is only present in an NTN cell. The ssb-TimeOffset indicates the time offset between the SSB from source and target satellite at the uplink time synchronization reference point. It is given in number of subframes. The t-ServiceStart indicates the time information on when the target satellite is going to start serving the area currently covered by the serving satellite. The field indicates a time in multiples of 10 ms after 00:00:00 on Gregorian calendar date 1 Jan. 1900 (midnight between Sunday, Dec. 31, 1899, and Monday, Jan. 1, 1900). The exact start time is between the time indicated by the value of this field minus 1 and the time indicated by the value of this field.

Some solutions of a RACH-less access process during the satellite switch with resynchronization involves a UE and source satellites (e.g. a source SAT-1 and a source SAT-2). The UE will conduct the following steps during a soft-satellite switch: at t-switch (i.e., any time between t-ServiceStart and t-Service), the UE suspends UL operations towards the source satellite (i.e., UL synchronization loss), upon DL synchronization acquisition, the UE applies new timing and resumes UL synchronization towards the target satellite (this can occur before, at or after t-Service). For the first (1st) UL transmission, the UE triggers TA reporting scheduling request (TAR-SR) via PUCCH scheduling request (SR) or configured grant (CG)/DG. If TimeAlignmentTimer (TAT) expires, the UE fallbacks to RACH-based access.

In the soft satellite switch, the UE can apply timing of the target satellite and start physical downlink control channel (PDCCH) monitoring for a scheduling grant before t-Service. In fact, it is only defined that the UE performs the satellite resynchronization between t-ServiceStart and t-Service (see Clause 5.2.2.4.21 in TS38.331). The problem of this procedure is that it is up to UE implementation the moment when the UE triggers the resynchronization, being the NW unaware on when exactly that will occur. The NW does not know when the UE will re-sync (i.e. resynchronization) with the target satellite, thus, it cannot know whether the UE should be scheduled via source or target satellite during the time window between t-ServiceStart and t-Service. This issue may lead to inefficient use of scheduling resources and it can increase the downlink interference (i.e., source satellite and target satellite coverages are overlapping and the NW cannot coordinate resources since it cannot control when the UE will re-sync). A normal network implementation will simply not schedule any UE during the overlap, leading to waste of resources and degrading the performance.

Some other solutions propose that all UEs resume UL operations at t-Service, so the NW will know exactly the time when the uplink transmissions will start towards the target satellite. This may be a valid solution but it may fall short because it will result on a scheduling request (SR) burst. In order to mitigate this issue, the NW can spread the SR resources so UEs send SRs in a more distributed manner, however, the burst is difficult to avoid. Apart from this, another issue would be an overload of the Physical Uplink Shared Channel (PUSCH) allocations for e.g., TA reporting. The UE is required to trigger a TA reporting for 1st UL transmission. If a bunch of UEs send the SR for requesting UL transmission (e.g., for TA reporting), the NW will be overloaded for TA reporting by allocating PUSCH transmissions. Resuming all UL transmissions at t-Service may overload the NW scheduling PUSCH transmissions and it can result in UEs experiencing longer interruption times (i.e., the NW cannot schedule all UEs right after t-Service and needs to spread them over time).

In such solutions, all UEs resume uplink operations at t-service, it is unclear to which downlink they listen until t-service. It may be logical they listen to the source satellite. This however leads to the disadvantage that all UEs are scheduled through the source satellite between t-servicestart and t-service, meaning only the transmit power of one satellite can be used. When traffic can be spread over 2 satellites, likely not all PRB can be used for interference reasons, but all power can be used while coordinating the resources. This however requires some UEs switch earlier than others, i.e. not all at t-service.

In view of these analysis and considerations, a new solution is proposed in some embodiments of the present disclosure. In some aspects, the NW and the UE could benefit from a more flexible solution where both parts are aware of when the first UL transmission will occur but the transmissions are distributed over time (between t-ServiceStart and t-Service) to alleviate the scheduling load and enhance the UE experience. It is noted that the time between t-ServiceStart and t-Service can be considerable and therefore good use of resources during that period can lead to significant capacity increases.

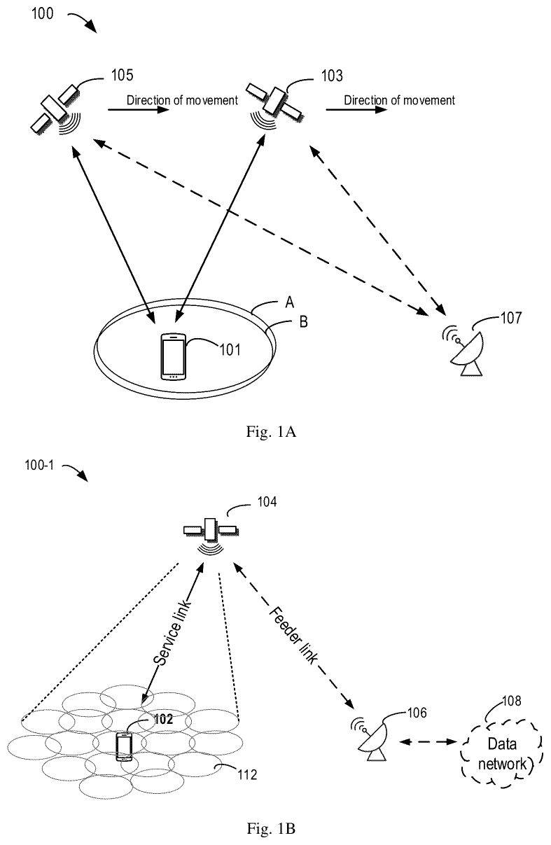

Principles and embodiments of the present disclosure will be described in detail below with reference to the accompanying drawings. Reference is first made to FIG. 1A, which illustrates an example communication system 100 (or referred to as communication network) in which embodiments of the present disclosure may be implemented. The system 100, for example, a communication network, includes a plurality of network device(s) and terminal device(s), such as a terminal device 101 and network devices 103 and 105. In NR NTN scenarios, the network devices 103 and 105 may be NTN devices, for example, a satellite-1 and a satellite-2, respectively. In some examples, the satellite-1 or the satellite-2 may be a low earth orbiting (LEO) satellite, a medium earth orbiting (MEO) satellite, or a geostationary earth orbiting (GEO) satellite. The terminal device 101 may communicate with the network device 103 or 105. In some examples, the system 100 may also include a network device 107, for example, a ground station, e.g. a gateway (GW) or a gNB. The network device 103 or 105 (e.g. the NTN device) may function as a transmission relay node between the network device 107 and the terminal device 101 in a transparent manner.

It is to be understood that the number of network devices and terminal devices is only for the purpose of illustration without suggesting any limitations. The system 100 may include any suitable number of network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Some examples of satellite switching may be described with reference to FIG. 1A. PCI is kept unchanged in a transparent-based EFC deployment. During the satellite switching, a UE (an example of the terminal device 101), which is stationary, is being served by the satellite-1 (an example of the network device 103, providing a cell A). As the satellite-1 moves away from the UE and the satellite-2 (an example of the network device 105) gets closer, the NW (e.g. the network device 107) indicates when the satellite switching will occur and how to perform re-synchronization to the new cell. Once the satellite-2 takes over serving the area (i.e. a cell B), the UE performs DL/UL synchronization operations to re-connect. In such examples, even though the UE is being served by a new satellite, it does not change the serving gNB so it can keep the cell configuration. The satellite-1 and the satellite-2 are configured with the same PCI, same UE context and same protocol stack (including SSB generation, coding/decoding, modulation/demodulation, same CORESET configuration, and switch routing).

However, from the UE's reference, the satellite-1 and the satellite-2 introduce different frequency (i.e., Doppler) and timing drifts (the propagation paths towards Satellite-1 and Satellite-2 are different). The satellite switching can be broken down in two additional scenarios: i) hard satellite switching and ii) soft satellite switching. The latter considers a certain cell overlapping between the NTN cell radiated by Satellite-1 and Satellite-2, while the former considers no overlapping between the old and the new cell (note that the UE should consider certain interruption time to pre-compensate frequency and timing of the new cell). For the soft satellite switching it is assumed that satellite-1 and the satellite-2 are transmitting SSBs offset in time, thereby allowing (in theory) the UE to gracefully switch to the new (incoming) satellite.

FIG. 1B illustrates an example architecture of a non-terrestrial network. As shown in FIG. 1B, the example architecture 100-1, may include a plurality of network device(s) and terminal device(s), such as a terminal device 102 and network devices 104 and 106. In some examples, the network device 104 may be a satellite or a UAS platform. The network device 106 may be a gateway. The terminal device 102 are in a beam footprint among a plurality of beam footprints. One of the plurality of beam footprints may be shown at 112. There is a service link between the terminal device 102 and the network device 104. There is a feeder link between the network device 104 and the network device 106. In some examples, the system 100-1 may also include a data network 108. The network device 106 and the data network 108 (e.g., the Internet, an intranet, a wide area network, etc.) may connect to each other over a wired and/or wireless network. Additionally or alternatively, the network device 106 may be connected to other core network elements not shown in FIG. 1B, such as servers, access points, switches, routers, nodes, etc.

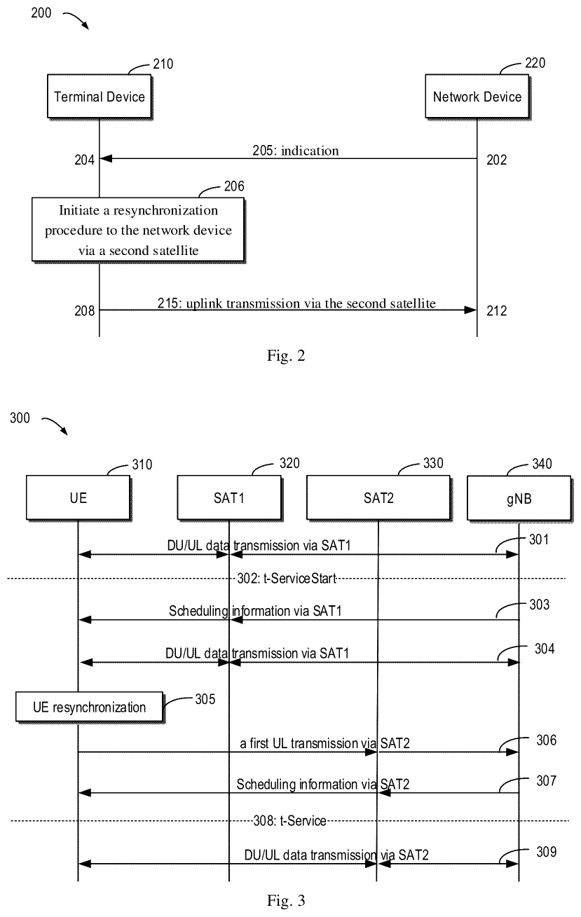

Reference is now made to FIG. 2, which shows a process for satellite switch with resynchronization according to some embodiments of the present disclosure. As shown in FIG. 2, in the process 200, a terminal device 210 and a network device 220 are involved. The terminal device 210 may be an example of the terminal device 101 mentioned in FIG. 1A. The network device 220 may be an example of the network device 107 in FIG. 1A. In some examples, the terminal device 210 may be a UE or another terminal device. The network device 220 may be a base station or a gNB, etc.

In the process 200, the network device 220 may transmit (202), to the terminal device 210, an indication 205 for determining time for at least one operation associated with switching from a first satellite to a second satellite. In some examples, the first satellite may be referred to as a source satellite (with reference to FIG. 1A, the network device 103), and the second satellite may be referred to as a target satellite (with reference FIG. 1A, the network device 105). The at least one operation may comprise (i) initiating a resynchronization procedure to the network device via the second satellite and/or (ii) performing an uplink transmission via the second satellite. On the terminal device 210 side, the terminal device 210 may receive (204), from the network device 220, the indication 205 for determining time for the at least one operation above. After receiving the indication 205, the terminal device 210 may initiate (206) the resynchronization procedure to the network device 220 via the second satellite, and may transmit (208) the uplink transmission 215 to the network device 220 via the second satellite. On the network device 220 side, the network device 220 may receive (212), from the terminal device 210, the uplink transmission 215 via the second satellite. The details of the process 200 will be further described below.

In some examples, the time for the at least one operation above is during an overlapping time between a first time point and a second time point. For example, the time T may exist in the space [t-ServiceStart, t-Service). The t-Service may represent the second time point, and the second time point is a time point for the first satellite to stop serving for the terminal device 210 in an area covered by a serving satellite of the terminal device 210. The t-ServiceStart may represent the first time point, and the first time point is a time point for the second satellite to start serving an area covered by a serving satellite of the terminal device 210. In some examples, the switching from the first satellite to the second satellite may be soft satellite switching during the overlapping time. In some examples, prior to the first time point, the network device 220 may exchange data with the terminal device 210 via the first satellite, and may determine optimal resynchronization time for the terminal device 210.

In some examples, the time for the at least one operation above may be calculated based on the indication 205. In such examples, the time may be referred to as time T. In some examples, the time T may be specific to the terminal device 210 or specific to a group of terminal devices including the terminal device 210. For example, the time T may be UE-specific or UE-group-specific. Some details of the examples for determining the time T will be given below.

In some examples, the indication may comprise a parameter indicating a function among a set of pre-configured functions. In some examples, the parameter may be a part of a system information block (SIB) broadcasted from the network device 220. After receiving the indication 205, the terminal device 210 may determine the time (i.e. the time T) based on the function using an identity (ID) of the terminal device 210 as an input. For example, the time T may be calculated based on a NW indication X, which is a parameter broadcasted as a part of a SIB19. In a soft satellite switch scenario, SatSwitchWithResync IE and t-ServiceStart IE may be broadcast as part of SIB19. This parameter may be a pointer (e.g. a pointer-T in some examples below) to a function (from a set of pre-configured functions), which uses the UE ID (an example of the ID of the terminal device 210) as the input. In some examples, the network device 220 may transmit the indication 205 prior to the first time point above. Accordingly, the terminal device 210 may receive the indication 205 prior to the first time point. Alternatively, the network device 220 may transmit the indication 205 after the first time point, and on the terminal device 210 side, the terminal device 210 may receive the indication 205 after the first time point. The function and the ID of the terminal device 210 are known by both the terminal device 210 and the network device 220. On the network device 220 side, the network device 220 may determine the time T based on the function using an identity (ID) of the terminal device as the input.

In some examples, the indication 205 may comprise a group number of a group of terminal devices including the terminal device 210. The terminal device 210 may determine the time (i.e. the time T) based on the group number and an ID of the terminal device 210. In some examples, the terminal device 210 may determine the time T using a formula for calculating the time T. In some examples, the formula may be T=floor((t-Service−t-ServiceStart)/N)*(UE-ID mod N), in which the T represents the time to be calculated. The t-Service represents the second time point above. The t-ServiceStart represents the first time point above. The N represents the group number. The UE-ID represents the ID of the terminal device 210. The function floor( ) represents a floor function. The mod represents a modulo operation. For example, the NW indicates a group number N in which each UE is distributed in a group and the time T is calculated using the formula above. In some examples, the ID of the terminal device 210 may be C-RNTI, IMSI or any unique identity of the terminal device 210. On the network device 220 side, the network device 220 may determine the time T in the same way (based on the group number and the ID of the terminal device) For example, the network device 220 may calculate the time T based on the formula above.

In some examples, the terminal device 210 may perform the at least one operation based on the received indication 205. As mentioned above, in some examples, the terminal device 210 may calculate the time T based on the indication 205. In such examples, the at least one operation may comprise the uplink transmission via the second satellite. The terminal device 210 may perform the following operations: initiating (206), before the time T, the resynchronization procedure to the network device 220 via the second satellite, and performing (e.g. transmitting) (208) the uplink transmission 215 to the network device 220 at the time. On the network device 220, the network device 220 may receive (212) the uplink transmission 215 from the terminal device 210 at the time.

Different from calculating the time T based on the pointer to a function or based on the group number N, in some other examples, during the time between the first time point (e.g. the t-ServiceStart) and the second time point (e.g. the t-Service), the NW may indicate over scheduling information when to perform the resynchronization. Some details of such examples will be given later.

In some examples, the indication 205 may be included in scheduling information and indicates that a scheduled transmission is to be a last transmission via the first satellite. In some examples, the indication 205 may be a single-bit indication. For example, a single bit indication in a DCI format carried over PDCCH may indicate that this resources allocation is the last one over the source satellite (and therefore, the UE must initiate the resynchronization procedure via the target satellite). In such examples, the terminal device 210 may perform the following operations: initiating (206) the resynchronization procedure to the network device 220 via the second satellite after the scheduled transmission; and performing (e.g. transmitting) (208) the uplink transmission 215 to the network device 220 via the second satellite. On the network device 220 side, based on the scheduled transmission, the network device 220 may determine that the terminal device 210 is to initiate the resynchronization procedure to the network device 220 via the second satellite and that the uplink transmission is to be received from the terminal device 210 via the second satellite.

In some examples, the indication 205 may be included in scheduling information and indicates a satellite identity (ID) of the second satellite. In some examples, the indication 205 may be a multi-bit indication. In such examples, the terminal device 210 may perform the following operations: based on receiving the satellite ID which is different from an identity of the first satellite, initiating (206) the resynchronization procedure to the network device 220 via the second satellite, and performing (e.g. transmitting) (208) the uplink transmission 215 to the network device 220 via the second satellite. For example, a multi-bit indication in ta DCI format over PDCCH may indicate a satellite ID such that when the UE acquires an allocation with a different satellite ID than the satellite ID belonging to the source satellite, the UE initiates the resynchronization procedure.

FIG. 3 illustrates an example process for satellite switch with resynchronization according to some embodiments of the present disclosure. As shown in FIG. 3, a UE 310, a satellite (i.e. SAT1) 320, a satellite (i.e. SAT2) 330 and a gNB 340 may be involved in the process 300. In some examples, the UE 310 may be an example of the terminal device 101. The satellite (i.e. SAT1) 320 may be a source satellite, and may be an example of the network device 103. The satellite (i.e. SAT2) 330 may be a target satellite, and may be an example of the network device 105. The gNB 340 may be an example of the network device 107.

In the process 300, at 301, before t-ServiceStart 302, the UE 310 exchanges data with the NW (e.g. the gNB 340) via the source satellite SAT1 320. During this period, the NW determines the optimal resynchronization time for each connected UE. After t-ServiceStart and before t-Service and close to the optimal resynchronization time determined above, at 303, the NW sends scheduling information (downlink control information (DCI) over PDCCH) including an indication that the scheduled transmission will be the last transmission over source satellite SAT1 320 (that is, there will be no subsequent transmission over the source satellite SAT1 320). At 304, the last scheduled transmission (UL/DL data transmission) via the source satellite SAT1 320 is performed. After the last scheduled transmission, at 305, the UE 310 performs the resynchronization. At 306, 307 and 309, the UE 310 resumes UL operations over the target satellite SAT2 330. The t-ServiceStart 302 may indicate the time information on when the target satellite (e.g. the SAT2 330) is going to start serving the area currently covered by the serving satellite. The t-Service 308 may indicate the time information on when a cell provided via NTN system (e.g. a cell provided by the SAT1 320) is going to stop serving the area it is currently covering.

Based on some embodiments described above, the NW may control over when the UE will perform the resynchronization. Scheduling request (SR) bursts at the t-Service may be avoided. NW overloading due to scheduling a large number of PUSCH transmissions may also be avoided. The UEs may suffer less risk of long interruptions. The NW and the UE have common understanding of the time when the UE will resume UL transmissions through the target satellite in a soft satellite switch with resynchronization scenario. The advantage is that the NW may schedule UEs 1st UL transmission through the target satellite in a distributed manner. At the same time this will also distribute the downlink transmissions with the associated advantage of more transmission power being available on board of the satellite.

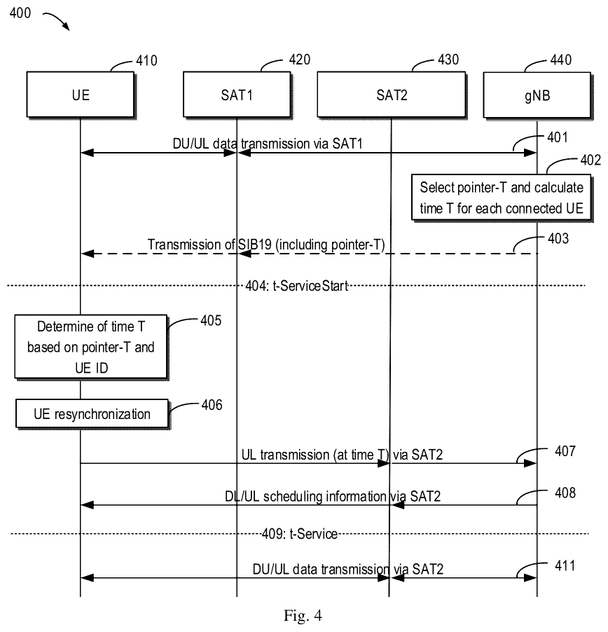

FIG. 4 illustrates another example process for satellite switch with resynchronization according to some embodiments of the present disclosure. In the process 400, a UE 410, a satellite (i.e. SAT1) 420, a satellite (i.e. SAT2) 430 and a gNB 440 are involved. In some examples, the UE 410 may be an example of the terminal device 101. The satellite (i.e. SAT1) 420 may be a source satellite, and may be an example of the network device 103. The satellite (i.e. SAT2) 430 may be a target satellite, and may be an example of the network device 105. The gNB 440 may be an example of the network device 107.

In the process 400, the steps or operations for distributing the UE access towards the target satellite are as below. At 401, before t-ServiceStart 404, the UE 410 exchanges data with the NW (e.g. the gNB 440) via the source satellite SAT1 420. During this period, at 402, the NW determines the optimal resynchronization time for each connected UE and includes pointer-T as part of SIB19. Before or after t-ServiceStart 404, at 403, the UE 410 acquires SIB19. At 405, the UE 410 determines the time T for access based on pointer-T and UE ID (e.g. an IMSI of the UE 410). Before the time T, at 406, the UE 410 initiates the resynchronization procedure. With reference to 407,408 and 411, the UE 410 resumes UL operations via target satellite SAT2 430, in which the UE 410 performs, at the time T, the first UL transmission via the SAT2 430.

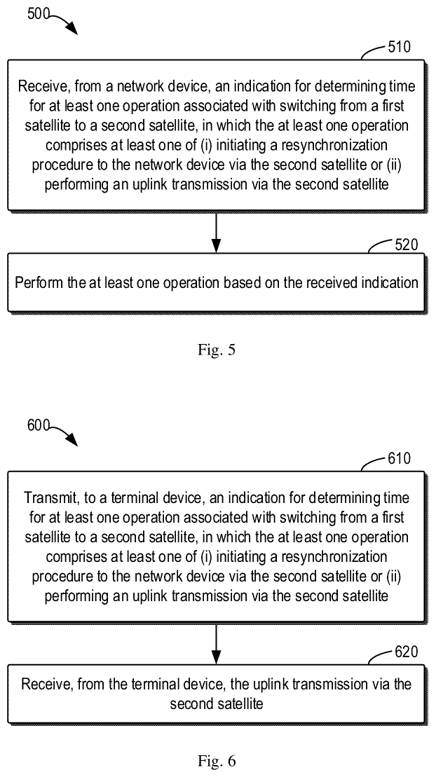

FIG. 5 illustrates a flowchart of a method implemented at a terminal device according to some embodiments of the present disclosure. The terminal device performing the method 500 may be an example of the terminal device 210 above.

At block 510, the terminal device may receive, from a network device, an indication for determining time for at least one operation associated with switching from a first satellite to a second satellite. The at least one operation may comprise at least one of (i) initiating a resynchronization procedure to the network device via the second satellite or (ii) performing an uplink transmission via the second satellite. At block 520, the terminal device may perform the at least one operation based on the received indication.

In some embodiments, the indication may comprise a parameter indicating a function among a set of pre-configured functions. The terminal device may determine the time based on the function using an identity (ID) of the terminal device as an input.

In some embodiments, the parameter may be a part of a system information block (SIB) broadcasted from the network device.

In some embodiments, the indication may be received prior to or after a first time point for the second satellite to start serving an area covered by a serving satellite of the terminal device.

In some embodiments, the indication may comprise a group number of a group of terminal devices including the terminal device. The terminal device may determine the time based on the group number and an ID of the terminal device.

In some embodiments, the terminal device may determine the time based on a formula for calculating the time. The formula may be: T=floor((t-Service−t-ServiceStart)/N)*(UE-ID mod N), wherein T represents the time, t-Service represents a second time point for the first satellite to stop serving for the terminal device in an area covered by a serving satellite of the terminal device, t-ServiceStart represents a first time point for the second satellite to start serving the area, N represents the group number, UE-ID represents the ID of the terminal device, floor( ) represents a floor function, and mod represents a modulo operation.

In some embodiments, the at least one operation may comprise the uplink transmission via the second satellite. The terminal device may perform the at least one operation by initiating, before the time, the resynchronization procedure to the network device via the second satellite, and performing the uplink transmission to the network device at the time.

In some embodiments, the time may be specific to the terminal device or specific to a group of terminal devices including the terminal device.

In some embodiments, the indication may be included in scheduling information and indicates that a scheduled transmission is to be a last transmission via the first satellite.

In some embodiments, the indication may be a single-bit indication.

In some embodiments, the terminal device may perform the at least one operation as below: initiating the resynchronization procedure to the network device via the second satellite after the scheduled transmission; and performing the uplink transmission to the network device via the second satellite.

In some embodiments, the indication may be included in scheduling information and indicates a satellite identity (ID) of the second satellite.

In some embodiments, the indication may be a multi-bit indication.

In some embodiments, the terminal device may perform the at least one operation as below: based on receiving the satellite ID which is different from an identity of the first satellite, initiating the resynchronization procedure to the network device via the second satellite; and performing the uplink transmission to the network device via the second satellite.

In some embodiments, the time is during an overlapping time between a first time point and a second time point, in which the first time point is for the second satellite to start serving for the terminal device in an area covered by a serving satellite of the terminal device, and the second time point is for the first satellite to stop serving for the terminal device in the area.

In some embodiments, the switching may be soft satellite switching during the overlapping time.

FIG. 6 illustrates a flowchart of a method implemented at a network device according to some embodiments of the present disclosure. The network device performing the method 600 may be an example of the network device 220 above.

At block 610, the network device may transmit, to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite. At block 620, the network device may receive, from the terminal device, the uplink transmission via the second satellite.

In some embodiments, the indication may comprise a parameter indicating among a set of pre-configured functions. The network device may determine the time based on the function using an identity (ID) of the terminal device as an input.

In some embodiments, the parameter may be a part of a system information block 19 (SIB19) broadcasted from the network device.

In some embodiments, the indication may be transmitted prior to or after a first time point for the second satellite to start serving an area covered by a serving satellite of the terminal device.

In some embodiments, the indication may comprise a group number of a group of terminal devices including the terminal device. The network device may determine the time based on the group number and an ID of the terminal device.

In some embodiments, the network device may determine the time in the following way: calculating the time based on a formula: T=floor((t-Service−t-ServiceStart)/N)*(UE-ID mod N), wherein T represents the time, t-Service represents a second time point for the first satellite to stop serving for the terminal device in an area covered by a serving satellite of the terminal device, t-ServiceStart represents a first time point for the second satellite to start serving the area, N represents the group number, UE-ID represents the ID of the terminal device, floor( ) represents a floor function, and mod represents a modulo operation.

In some embodiments, the at least one operation may comprise the uplink transmission via the second satellite. The network device may receive the uplink transmission from the terminal device at the time.

In some embodiments, the time may be specific to the terminal device or specific to a group of terminal devices including the terminal device.

In some embodiments, the indication may be included in scheduling information and indicates that a scheduled transmission is to be a last transmission via the first satellite.

In some embodiments, the indication may be a single-bit indication.

In some embodiments, the network device may, based on the scheduled transmission, determine that the terminal device is to initiate the resynchronization procedure to the network device via the second satellite and that the uplink transmission is to be received from the terminal device via the second satellite.

In some embodiments, the indication may be included in scheduling information and indicates a satellite identity (ID) of the second satellite.

In some embodiments, the indication may be a multi-bit indication.

In some embodiments, the time may be during an overlapping time between a first time point and a second time point. The first time point is for the second satellite to start serving for the terminal device in an area covered by a serving satellite of the terminal device, and the second time point is for the first satellite to stop serving for the terminal device in the area.

In some embodiments, the switching may be soft satellite switching during the overlapping time.

In some embodiments, the network device may, prior to a first time point for the second satellite to start serving an area covered by a serving satellite of the terminal device, exchange data with the terminal device via the first satellite; and determine optimal resynchronization time for the terminal device.

In some embodiments, an apparatus capable of performing any of the method 500 (for example, the terminal device) may comprise means for performing the respective steps of the method 500. The means may be implemented in any suitable form. For example, the means may be implemented in a circuitry or software module.

In some embodiments, the apparatus comprises means for receiving, from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and means for performing the at least one operation based on the received indication.

In some embodiments, the indication comprises a parameter indicating a function among a set of pre-configured functions, and the apparatus further comprises means for determining the time based on the function using an identity (ID) of the terminal device as an input.

In some embodiments, the parameter is a part of a system information block (SIB) broadcasted from the network device.

In some embodiments, the indication is received prior to or after a first time point for the second satellite to start serving an area covered by a serving satellite of the terminal device.

In some embodiments, the indication comprises a group number of a group of terminal devices including the terminal device, and the apparatus further comprises means for determining the time based on the group number and an ID of the terminal device.

In some embodiments, the means for determining the time comprises means for calculating the time based on a formula: T=floor((t-Service−t-ServiceStart)/N)*(UE-ID mod N), wherein T represents the time, t-Service represents a second time point for the first satellite to stop serving for the terminal device in an area covered by a serving satellite of the terminal device, t-ServiceStart represents a first time point for the second satellite to start serving the area, N represents the group number, UE-ID represents the ID of the terminal device, floor( ) represents a floor function, and mod represents a modulo operation.

In some embodiments, the at least one operation comprises the uplink transmission via the second satellite, and the means for performing the at least one operation comprises means for initiating, before the time, the resynchronization procedure to the network device via the second satellite; and means for performing the uplink transmission to the network device at the time.

In some embodiments, the time is specific to the terminal device or specific to a group of terminal devices including the terminal device.

In some embodiments, the indication is included in scheduling information and indicates that a scheduled transmission is to be a last transmission via the first satellite.

In some embodiments, the indication is a single-bit indication.

In some embodiments, the means for performing the at least one operation comprises means for initiating the resynchronization procedure to the network device via the second satellite after the scheduled transmission; and means for performing the uplink transmission to the network device via the second satellite.

In some embodiments, the indication is included in scheduling information and indicates a satellite identity (ID) of the second satellite.

In some embodiments, the indication is a multi-bit indication.

In some embodiments, the means for performing the at least one operation comprises means for, based on receiving the satellite ID which is different from an identity of the first satellite, initiating the resynchronization procedure to the network device via the second satellite; and means for performing the uplink transmission to the network device via the second satellite.

In some embodiments, the time is during an overlapping time between a first time point and a second time point, the first time point is for the second satellite to start serving for the terminal device in an area covered by a serving satellite of the terminal device, and the second time point is for the first satellite to stop serving for the terminal device in the area.

In some embodiments, the switching is soft satellite switching during the overlapping time.

In some embodiments, the apparatus further comprises means for performing other steps in some embodiments of the method 500. In some embodiments, the means comprises at least one processor; and at least one memory including computer program code, the at least one memory and computer program code configured to, with the at least one processor, cause the performance of the apparatus.

In some embodiments, an apparatus capable of performing any of the method 600 (for example, the network device) may comprise means for performing the respective steps of the method 600. The means may be implemented in any suitable form. For example, the means may be implemented in a circuitry or software module.

In some embodiments, the apparatus comprises means for transmitting, to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite; and means for receiving, from the terminal device, the uplink transmission via the second satellite.

In some embodiments, the indication comprises a parameter indicating among a set of pre-configured functions. The apparatus further comprises means for determining the time based on the function using an identity (ID) of the terminal device as an input.

In some embodiments, the parameter is a part of a system information block 19(SIB19) broadcasted from the network device.

In some embodiments, the indication is transmitted prior to or after a first time point for the second satellite to start serving an area covered by a serving satellite of the terminal device.

In some embodiments, the indication comprises a group number of a group of terminal devices including the terminal device. The apparatus further comprises means for determining the time based on the group number and an ID of the terminal device.

In some embodiments, the means for determining the time comprises means for calculating the time based on a formula: T=floor((t-Service−t-ServiceStart)/N)*(UE-ID mod N), wherein T represents the time, t-Service represents a second time point for the first satellite to stop serving for the terminal device in an area covered by a serving satellite of the terminal device, t-ServiceStart represents a first time point for the second satellite to start serving the area, N represents the group number, UE-ID represents the ID of the terminal device, floor( ) represents a floor function, and mod represents a modulo operation.

In some embodiments, the at least one operation comprises the uplink transmission via the second satellite. The apparatus further comprises means for receiving the uplink transmission from the terminal device at the time.

In some embodiments, the time is specific to the terminal device or specific to a group of terminal devices including the terminal device.

In some embodiments, the indication is included in scheduling information and indicates that a scheduled transmission is to be a last transmission via the first satellite.

In some embodiments, the indication is a single-bit indication.

In some embodiments, the apparatus further comprises means for, based on the scheduled transmission, determining that the terminal device is to initiate the resynchronization procedure to the network device via the second satellite and that the uplink transmission is to be received from the terminal device via the second satellite.

In some embodiments, the indication is included in scheduling information and indicates a satellite identity (ID) of the second satellite.

In some embodiments, the indication is a multi-bit indication.

In some embodiments, the time is during an overlapping time between a first time point and a second time point, the first time point is for the second satellite to start serving for the terminal device in an area covered by a serving satellite of the terminal device, and the second time point is for the first satellite to stop serving for the terminal device in the area.

In some embodiments, the switching is soft satellite switching during the overlapping time.

In some embodiments, the apparatus further comprises means for, prior to a first time point for the second satellite to start serving an area covered by a serving satellite of the terminal device, exchanging data with the terminal device via the first satellite; and means for determining optimal resynchronization time for the terminal device.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

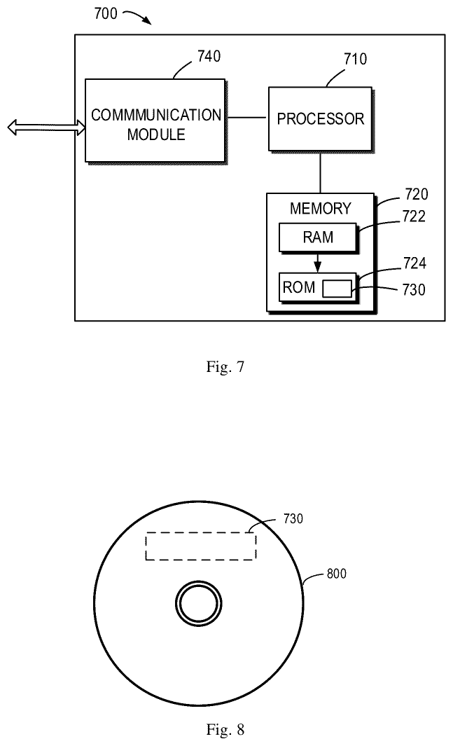

FIG. 7 is a simplified block diagram of a device 700 that is suitable for implementing embodiments of the present disclosure. The device 700 may be provided to implement the communication device, for example the terminal device or the network device. As shown, the device 700 includes one or more processors 710, one or more memories 720 coupled to the processor 710, and one or more communication modules 740 coupled to the processor 710.

The communication modules 740 is for bidirectional communications. The communication modules 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 2-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device comprising:
at least one processor: and
at least one memory storing instructions that, when executed by the at least one processor, cause the terminal device at least to:
receive, from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite and wherein the indication includes a first time point at which the second satellite begins serving an area covered by a serving satellite of the terminal device; and
perform the at least one operation based on the received indication.

2. The terminal device of claim 1, wherein the indication comprises a parameter indicating a function among a set of pre-configured functions, and the terminal device is further caused to:
determine the time based on the function using an identity (ID) of the terminal device as an input.

3. The terminal device of claim 2, wherein the parameter is a part of a system information block (SIB) broadcasted from the network device.

4. The terminal device of claim 2, wherein:
the indication is received prior to or after the first time point for the second satellite to start serving the area covered by the serving satellite of the terminal device.

5. The terminal device of claim 1, wherein the indication comprises a group number of a group of terminal devices including the terminal device, and the terminal device is further caused to:
determine the time based on the group number and an ID of the terminal device.

6. The terminal device of claim 5, wherein the terminal device is caused to determine the time by:
calculating the time based on a formula: T=floor((t-Service−t-ServiceStart)/N)*(UE-ID mod N), wherein T represents the time, t-Service represents a second time point for the first satellite to stop serving for the terminal device in the area covered by the serving satellite of the terminal device, t-ServiceStart represents the first time point for the second satellite to start serving the area, N represents the group number, UE-ID represents the ID of the terminal device, floor( ) represents a floor function, and mod represents a modulo operation.

7. The terminal device of claim 2, wherein the at least one operation comprises the uplink transmission via the second satellite, and the terminal device is caused to perform the at least one operation by:
initiating, before the time, the resynchronization procedure to the network device via the second satellite: and
performing the uplink transmission to the network device at the time.

8. The terminal device of claim 7, wherein the time is specific to the terminal device or specific to a group of terminal devices including the terminal device.

9. The terminal device of claim 1, wherein the indication is included in scheduling information and indicates that a scheduled transmission is to be a last transmission via the first satellite.

10. The terminal device of claim 9, wherein the indication is a single-bit indication.

11. The terminal device of claim 9, wherein the terminal device is caused to perform the at least one operation by:
initiating the resynchronization procedure to the network device via the second satellite after the scheduled transmission; and
performing the uplink transmission to the network device via the second satellite.

12. The terminal device of claim 1, wherein the indication is included in scheduling information and indicates a satellite identity (ID) of the second satellite.

13. The terminal device of claim 12, wherein the indication is a multi-bit indication.

14. The terminal device of claim 12, wherein the terminal device is caused to perform the at least one operation by:
based on receiving the satellite ID which is different from an identity of the first satellite, initiating the resynchronization procedure to the network device via the second satellite; and
performing the uplink transmission to the network device via the second satellite.

15. The terminal device of claim 1, wherein:
the time is during an overlapping time between the first time point and a second time point,
the first time point is for the second satellite to start serving for the terminal device in the area covered by the serving satellite of the terminal device, and
the second time point is for the first satellite to stop serving for the terminal device in the area.

16. The terminal device of claim 15, wherein the switching is soft satellite switching during the overlapping time.

17. A network device comprising:
at least one processor: and
at least one memory storing instructions that, when executed by the at least one processor, cause the network device at least to:
transmit, to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite and wherein the indication includes a first time point at which the second satellite begins serving an area covered by a serving satellite of the terminal device; and
receive, from the terminal device, the uplink transmission via the second satellite.

18. The network device of claim 17, wherein the indication comprises a parameter indicating a function among a set of pre-configured functions, and the network device is further caused to:
determine the time based on the function using an identity (ID) of the terminal device as an input.

19. The network device of claim 18, wherein the parameter is a part of a system information block 19 (SIB19) broadcasted from the network device.

20. The network device of claim 18, wherein:
the indication is transmitted prior to or after the first time point for the second satellite to start serving the area covered by the serving satellite of the terminal device.

21. The network device of claim 17, wherein the indication comprises a group number of a group of terminal devices including the terminal device, and the network device is further caused to:
determine the time based on the group number and an ID of the terminal device.

22. The network device of claim 21, wherein the network device is caused to determine the time by:
calculating the time based on a formula: T=floor((t-Service−t-ServiceStart)/N)*(UE-ID mod N), wherein T represents the time, t-Service represents a second time point for the first satellite to stop serving for the terminal device in the area covered by the serving satellite of the terminal device, t-ServiceStart represents the first time point for the second satellite to start serving the area, N represents the group number, UE-ID represents the ID of the terminal device, floor( ) represents a floor function, and mod represents a modulo operation.

23. The network device of claim 18, wherein the at least one operation comprises the uplink transmission via the second satellite, and the network device is further caused to:
receiving the uplink transmission from the terminal device at the time.

24. The network device of claim 23, wherein the time is specific to the terminal device or specific to a group of terminal devices including the terminal device.

25. The network device of claim 17, wherein the indication is included in scheduling information and indicates that a scheduled transmission is to be a last transmission via the first satellite.

26. The network device of claim 25, wherein the indication is a single-bit indication.

27. The network device of claim 25, wherein the network device is further caused to:
based on the scheduled transmission, determine that the terminal device is to initiate the resynchronization procedure to the network device via the second satellite and that the uplink transmission is to be received from the terminal device via the second satellite.

28. The network device of claim 17, wherein the indication is included in scheduling information and indicates a satellite identity (ID) of the second satellite.

29.-32. (canceled)

33. A method comprising:
receiving, at a terminal device and from a network device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite, and wherein the indication includes a first time point at which the second satellite begins serving an area covered by a serving satellite of the terminal device; and
performing the at least one operation based on the received indication.

34. A method comprising:
transmitting, at a network device and to a terminal device, an indication for determining time for at least one operation associated with switching from a first satellite to a second satellite, wherein the at least one operation comprises at least one of (i) initiating a resynchronization procedure to the network device via the second satellite or (ii) performing an uplink transmission via the second satellite, and wherein the indication includes a first time point at which the second satellite begins serving an area covered by a serving satellite of the terminal device; and
receiving, from the terminal device, the uplink transmission via the second satellite.
